(19) United States
(12) Patent Application Publication
(10) Pub. No.: US 2012/0258191 A1
(43) Pub. Date: Oct. 11, 2012

(54) Apparatus for Fabricating Light Guide Plate

(75) Inventors: Dongwook KIM, Gyeonggi-do (KR); Byongil Lee, Gyeonggi-do (KR); Jinsu Son, Gyeongbuk (KR)

(73) Assignee: LG Display Co., Ltd.

(21) Appl. No.: 13/337,419

(22) Filed: Dec. 27, 2011

(30) Foreign Application Priority Data
Apr. 5, 2011 (KR) 10-2011-0031247

(51) Int. Cl. B29C 59/04

(52) U.S. Cl. 425/385

(57) ABSTRACT

An apparatus for fabricating a light guide plate includes: a material supply unit supplying a material; a first processing unit including a roll rotating to extrude the material supplied from the material supply unit; and a second processing unit including a roll rotating to form a pattern on one surface of the extruded material before the material extruded by the first processing unit is cooled.

This application claims the benefit of Korean Patent Application No. 10-2011-0031247 filed on Apr. 5, 2011, which is hereby incorporated by reference.

### BACKGROUND

1. Field

The present invention relates to an apparatus for fabricating light guide plate.

2. Related Art

A liquid crystal display (LCD) device is classified into a light receiving display device. The LCD device displays an image upon receiving a light source from a backlight unit positioned at a lower side of a liquid crystal panel. The backlight unit, which serves to effectively provide light to the liquid crystal panel, includes a light source, a light guide plate, an optical film layer, or the like.

The light guide plate serves to change a point source of light output from a light source into a surface source of light. The light guide plate is fabricated by extruding a melt material, cooling the extruded material for about five days, cutting the cooled material into a size of a light guide plate, and then, forming a certain pattern on one surface thereof by using a roll stamping process.

However, in the apparatus for fabricating a light guide plate according to the related art, after the melt material is extruded, the temperature of the extruded material is decreased, and then, the material is heated again to perform roll stamping thereon, and in this case, protection paper for protecting the extruded material should be attached and then detached, and each sheet must be separately processed, degrading productivity, and the like. Thus, an improvement is required.

### SUMMARY

An aspect of the present invention provides an apparatus for fabricating a light guide plate, including: a material supply unit supplying a material; a first processing unit including a roll rotating to extrude the material supplied from the material supply unit; and a second processing unit including a roll rotating to form a pattern on one surface of the extruded material before the material extruded by the first processing unit is cooled.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is a schematic view showing the configuration of an apparatus for fabricating a light guide plate according to a first embodiment of the present invention.

FIG. 2 is a schematic view showing the configuration of an apparatus for fabricating a light guide plate according to a second embodiment of the present invention.

FIG. 3 is a schematic view showing the configuration of an apparatus for fabricating a light guide plate according to a third embodiment of the present invention.

FIG. 4 is a schematic view showing the configuration of an apparatus for fabricating a light guide plate according to a fourth embodiment of the present invention.

FIG. 5 is a schematic view showing the configuration of an apparatus for fabricating a light guide plate according to a fifth embodiment of the present invention.

FIG. 6 is a partial perspective view of a light guide plate fabricated according to an embodiment of the present invention.

FIG. 7 is a view showing a plane and a section of a pattern formed on an area A1-A2 of FIG. 6.

FIG. 8 is a partial perspective view of a light guide plate fabricated according to another embodiment of the present invention.

FIG. 9 is a partial sectional view of a liquid crystal display (LCD) device including a light guide plate fabricated according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

Embodiments of the present invention will now be described with reference to the accompanying drawings.

### First Embodiment

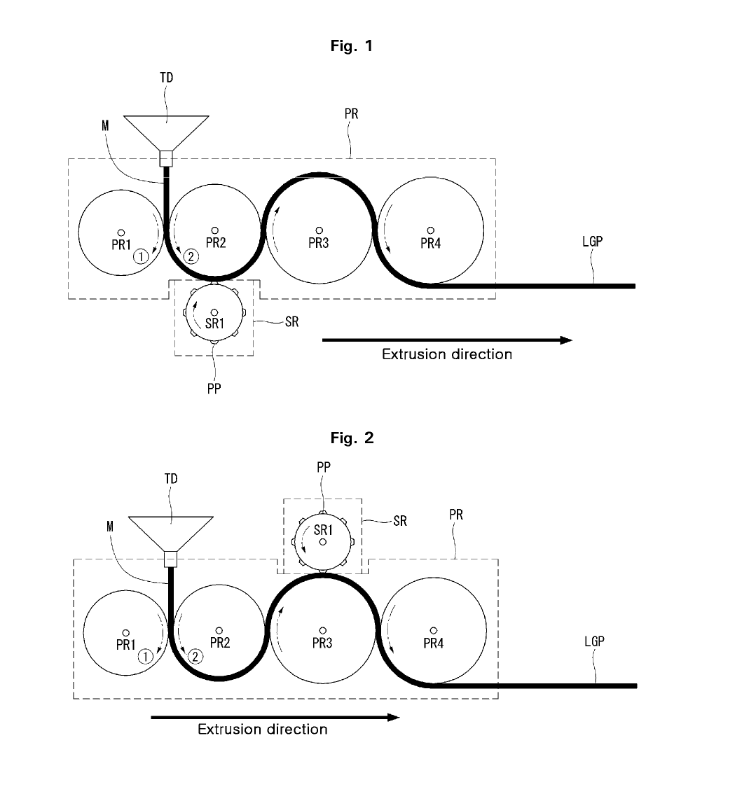

FIG. 1 is a schematic view showing the configuration of an apparatus for fabricating a light guide plate according to a first embodiment of the present invention.

As shown in FIG. 1, the apparatus for fabricating a light guide plate according to a first embodiment of the present invention includes a material supply unit TD, a first processing unit PR, and a second processing unit SR.

The material supply unit TD serves to supply a melt material M. The material supply unit TD may be configured as a T-die having a wide slit shape. As the material, for example, a resin may be selected.

The first processing unit PR serves to extrude the material M supplied from the material supply unit TD. The first processing unit PR includes rolls rotating to extrude M.

The rolls included in the first processing unit PR may include first and second polishing rolls PR1 and PR2 rotating in a first direction \textcircled{1} and in a second direction \textcircled{2}, respectively, to extrude the material M supplied from the material supply unit TD and third and fourth polishing rolls PR3 and PR4 rotating in the first direction \textcircled{1} and in the second direction \textcircled{2}, respectively, to extrude the material M which has been extruded by the first and second polishing rolls RP1 and PR2.

The second processing unit SR serves to form a pattern on one surface of the extruded material M before the material M extruded by the first processing unit PR is cooled. The second processing unit SR includes rolls rotating to form a pattern on one surface of the extruded material M before the extruded material M is cooled.

The second processing unit SR includes a pattern roll SR1 disposed at a lower side of the second polishing roll PR2 and rotating in the first direction \textcircled{1}, the opposite direction from that of the second polishing roll PR2, to form a pattern on one surface of the extruded material M.

The apparatus for fabricating a light guide plate according to the first embodiment of the present invention fabricates the light guide plate by forming a pattern on one surface of the extruded material M in a manner of roll stamping by the pattern roll SR1 disposed at the lower side of the second polishing roll PR2 before the material M extruded is cooled.

### Second Embodiment

FIG. 2 is a schematic view showing the configuration of an apparatus for fabricating a light guide plate according to a second embodiment of the present invention.

As shown in FIG. 2, the apparatus for fabricating a light guide plate according to a second embodiment of the present invention includes a material supply unit TD, a first processing unit PR, and a second processing unit SR.

The material supply unit TD serves to supply a melt material M. The material supply unit TD may be configured as a T-die having a wide slit shape. As the material, for example, a resin may be selected.

The first processing unit PR serves to extrude the material M supplied from the material supply unit TD. The first processing unit PR includes rolls rotating to extrude M.

The rolls included in the first processing unit PR may include first and second polishing rolls PR1 and PR2 rotating in a first direction \textcircled{1} and in a second direction \textcircled{2}, respectively, to extrude the material M supplied from the material supply unit TD and third and fourth polishing rolls PR3 and PR4 rotating in the first direction \textcircled{1} and in the second direction \textcircled{2}, respectively, to extrude the material M which has been extruded by the first and second polishing rolls RP1 and PR2.

The second processing unit SR serves to form a pattern on one surface of the extruded material M before the material M extruded by the first processing unit PR is cooled. The second processing unit SR includes rolls rotating to form a pattern on one surface of the extruded material M before the extruded material M is cooled.

The second processing unit SR includes a pattern roll SR1 disposed at an upper side of the third polishing roll PR3 and rotating in the first direction \textcircled{1}, the opposite direction from that of the third polishing roll PR3, to form a pattern on one surface of the extruded material M. Protrusions PP are formed on the pattern roll SR1 in order to from a pattern on one surface of the extruded material M.

The apparatus for fabricating a light guide plate according to the second embodiment of the present invention fabricates the light guide plate by forming a pattern on one surface of the extruded material M in a manner of roll stamping by the pattern roll SR1 disposed at the upper side of the third polishing roll PR3 before the material M extruded is cooled.

### Third Embodiment

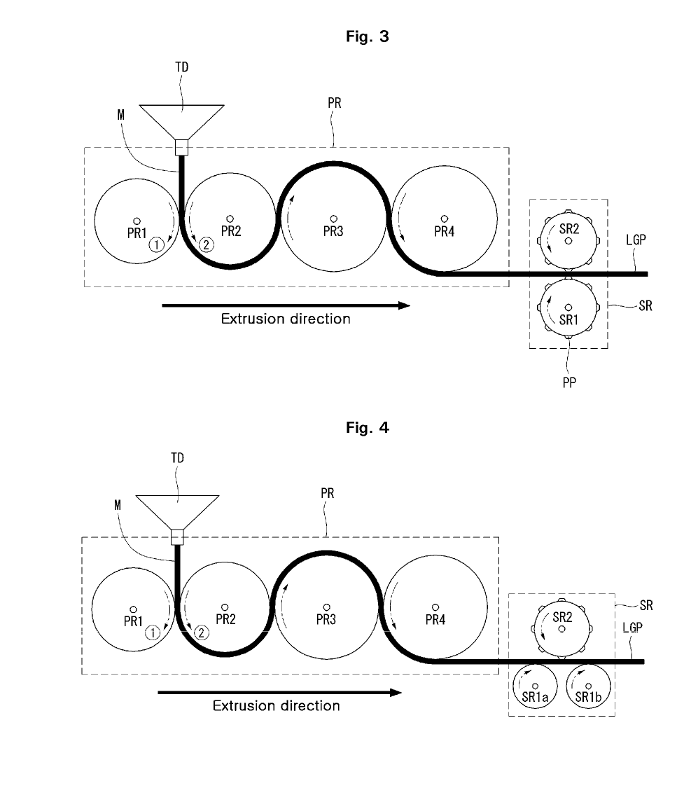

FIG. 3 is a schematic view showing the configuration of an apparatus for fabricating a light guide plate according to a third embodiment of the present invention.

As shown in FIG. 3, the apparatus for fabricating a light guide plate according to a third embodiment of the present invention includes a material supply unit TD, a first processing unit PR, and a second processing unit SR.

The material supply unit TD serves to supply a melt material M. The material supply unit TD may be configured as a T-die having a wide slit shape. As the material, for example, a resin may be selected.

The first processing unit PR serves to extrude the material M supplied from the material supply unit TD. The first processing unit PR includes rolls rotating to extrude M.

The rolls included in the first processing unit PR may include first and second polishing rolls PR1 and PR2 rotating in a first direction \textcircled{1} and in a second direction \textcircled{2}, respectively, to extrude the material M supplied from the material supply unit TD and third and fourth polishing rolls PR3 and PR4 rotating in the first direction \textcircled{1} and in the second direction \textcircled{2}, respectively, to extrude the material M which has been extruded by the first and second polishing rolls RP1 and PR2.

The second processing unit SR serves to form a pattern on at least one of one surface and the other surface of the extruded material M before the material M extruded by the first processing unit PR is cooled. The second processing unit SR includes rolls rotating to form a pattern on at least one of one surface and the other surface of the extruded material M before the extruded material M is cooled.

Rolls included in the second processing unit SR include a first pattern roll SR1 disposed to be spaced apart from the fourth polishing roll PR4 and rotating in the first direction \textcircled{1} and a second pattern roll SR2 disposed on the first pattern roll SR1 and rotating in the second direction \textcircled{2}. The first pattern roll SR1 and the second pattern roll SR2 form a pattern on at least one of one surface and the other surface of the protruded material M which has passed through the fourth polishing roll PR4.

The apparatus for fabricating a light guide plate according to the third embodiment of the present invention fabricates the light guide plate by forming a pattern on at least one of one surface and the other surface of the extruded material M in a manner of roll stamping by the first pattern roll SR1 and the second pattern roll SR2 disposed to be spaced apart from the fourth polishing roll PR4 before the material M extruded is cooled. Meanwhile, in case of the extruded material M, since a pattern is formed on at least one of one surface and the other surface thereof, protrusions PP are formed on at least one of the first pattern roll SR1 and the second pattern roll SR2 in order to from a pattern.

### Fourth Embodiment

FIG. 4 is a schematic view showing the configuration of an apparatus for fabricating a light guide plate according to a fourth embodiment of the present invention.

As shown in FIG. 4, the apparatus for fabricating a light guide plate according to a second embodiment of the present invention includes a material supply unit TD, a first processing unit PR, and a second processing unit SR.

The material supply unit TD serves to supply a melt material M. The material supply unit TD may be configured as a T-die having a wide slit shape. As the material, for example, a resin may be selected.

The first processing unit PR serves to extrude the material M supplied from the material supply unit TD. The first processing unit PR includes rolls rotating to extrude M.

The rolls included in the first processing unit PR may include first and second polishing rolls PR1 and PR2 rotating in a first direction \textcircled{1} and in a second direction \textcircled{2}, respectively, to extrude the material M supplied from the material supply unit TD and third and fourth polishing rolls PR3 and PR4 rotating in the first direction \textcircled{1} and in the second direction \textcircled{2}, respectively, to extrude the material M which has been extruded by the first and second polishing rolls RP1 and PR2.

The second processing unit SR serves to form a pattern on one surface of the extruded material M before the material M extruded by the first processing unit PR is cooled. The second processing unit SR includes rolls rotating to form a pattern on one surface of the extruded material M before the extruded material M is cooled.

Rolls included in the second processing unit SR include a pair of first pattern rolls SR1a and SR1b disposed to be spaced apart from the fourth polishing roll PR4, spaced apart from each other, and rotating in the first direction \textcircled{1}, and a second pattern roll SR2 disposed between the first patterns SR1a and SR1b thereon and rotating in the second direction \textcircled{2}. The pair of first pattern rolls SR1a and SR1b and the second pattern roll SR2 form a pattern on one surface of the extruded material M which has passed through the fourth polishing roll PR4.

The apparatus for fabricating a light guide plate according to the fourth embodiment of the present invention fabricates the light guide plate by forming a pattern on one surface of the extruded material M in a manner of roll stamping by the pair of first pattern rolls SR1a and SR1b disposed to be spaced apart from the fourth polishing roll PR4 and the second pattern roll SR2 before the material M extruded is cooled. Meanwhile, in the case of the extruded material M, since a pattern is formed only one surface thereof, protrusions PP are formed to form a pattern on only one of the first pattern roll SR1 and the second pattern roll SR2.

### Fifth Embodiment

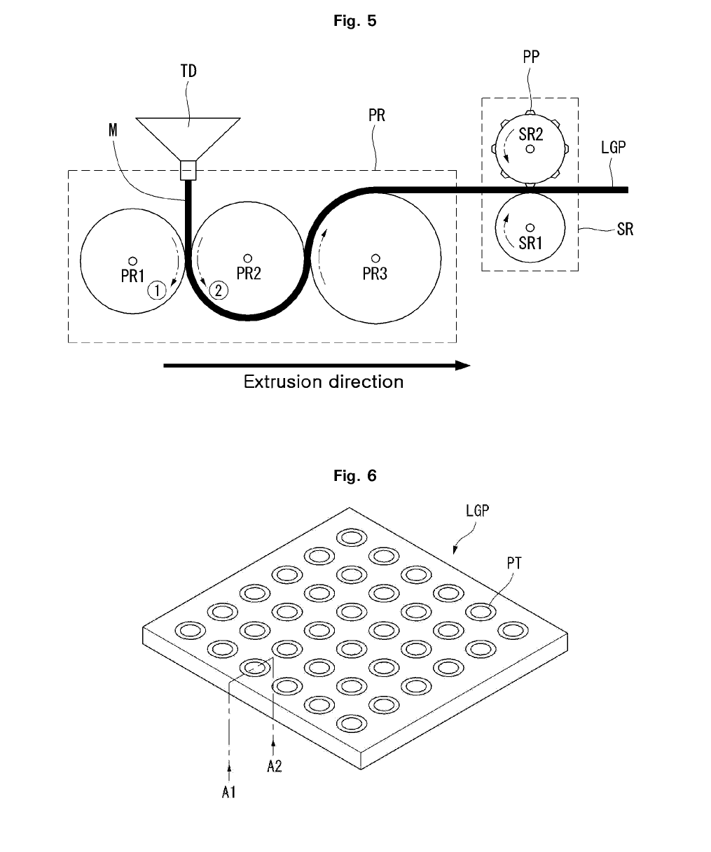

FIG. 5 is a schematic view showing the configuration of an apparatus for fabricating a light guide plate according to a fifth embodiment of the present invention.

As shown in FIG. 5, the apparatus for fabricating a light guide plate according to a fifth embodiment of the present invention includes a material supply unit TD, a first processing unit PR, and a second processing unit SR.

The material supply unit TD serves to supply a melt material M. The material supply unit TD may be configured as a T-die having a wide slit shape. As the material, for example, a resin may be selected.

The first processing unit PR serves to extrude the material M supplied from the material supply unit TD. The first processing unit PR includes rolls rotating to extrude M.

The rolls included in the first processing unit PR may include first and second polishing rolls PR1 and PR2 rotating in a first direction \textcircled{1} and in a second direction \textcircled{2}, respectively, to extrude the material M supplied from the material supply unit TD and a third polishing roll PR3 rotating in the first direction \textcircled{1} to extrude the material M which has been extruded by the first and second polishing rolls RP1 and PR2.

The second processing unit SR serves to form a pattern on one surface of the extruded material M before the material M extruded by the first processing unit PR is cooled. The second processing unit SR includes rolls rotating to form a pattern on one surface of the extruded material M before the extruded material M is cooled.

Rolls included in the second processing unit SR include a first pattern roll SR1 disposed to be spaced apart from the third polishing roll PR3 and rotating in the first direction \textcircled{1} and a second pattern roll SR2 disposed on the first pattern roll SR1 and rotating in the second direction \textcircled{2}. The first pattern roll SR1 and the second pattern roll SR2 form a pattern on one surface of the protruded material M which has passed through the fourth polishing roll PR3.

The apparatus for fabricating a light guide plate according to the fifth embodiment of the present invention fabricates the light guide plate by forming a pattern on one surface of the extruded material M in a manner of roll stamping by the first pattern roll SR1 and the second pattern roll SR2 disposed to be spaced apart from the third polishing roll PR3 before the material M extruded is cooled. Meanwhile, in the case of the extruded material M, since a pattern is formed only on one surface thereof, protrusions PP are formed on at least one of the first pattern roll SR1 and the second pattern roll SR2 in order to from a pattern.

As described above in the first to fifth embodiments of the present invention, the light guide plate (LGP) can be fabricated by extruding the melt material M and performing roll stamping thereon before the extruded material M is cooled.

In order to fabricate the light guide plate in the foregoing manner, the first processing unit PR includes a cooling unit. As the cooling unit, a water cooling system for circulating a liquid such as water, or the like, therein to cool the surface of the rolls or an air cooling system for circulating a gas such as air, or the like, may be installed. Alternatively, a system for cooling only a space in which the first processing unit PR is positioned may be provided as the cooling unit.

An example of the light guide plates fabricated according to the first to fifth embodiments of the present invention will be described as follows.

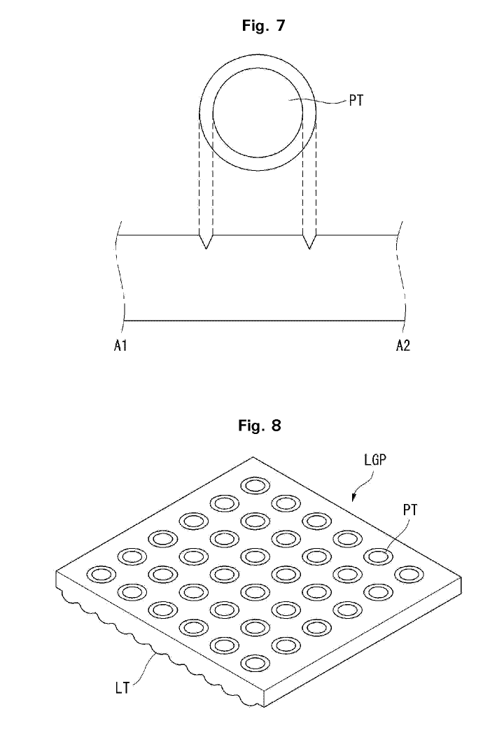

FIG. 6 is a partial perspective view of a light guide plate fabricated according to an embodiment of the present invention. FIG. 7 is a view showing a plane and a section of a pattern formed on an area A1-A2 of FIG. 6.

As shown in FIGS. 6 and 7, the light guide plate fabricated according to an embodiment of the present invention includes dot patterns PT formed on one surface thereof. Namely, the second processing unit SR described in the first to fifth embodiments of the present invention form the dot patterns PT on one surface of the extruded material M.

The patterns PT formed on one surface of the light guide plate are formed as recesses on the surface thereof to have a circular dot-like shape. However, the dot patterns PT formed on one surface of the light guide plate may have various other dot-like shapes such as an oval shape, a polygonal shape, or the like.

Another example of the light guide plates fabricated according to the first to fifth embodiments of the present invention will be described as follows.

FIG. 8 is a partial perspective view of a light guide plate fabricated according to another embodiment of the present invention.

As shown in FIG. 8, in an embodiment of the present invention, lenticular patterns LT may be formed on the opposite side of the side on which the dot patterns PT are formed, by providing an embossing shape to the roll included in the first processing unit PR or the roll included in the second processing unit SR. When the lenticular patterns LT or prism-like patterns are formed on the other surface, in the case of the roll included in the second processing unit SR, protrusions may be formed to correspond to one surface and the other surface of the extruded material.

A process for further providing a structure such as forming haze or a reflective member on the other surface based on the light guide plate illustrated in FIGS. 6 to 8 may be configured by using the apparatus for fabricating a light guide plate according to an embodiment of the present invention.

The light guide plate fabricated according to the first to fifth embodiments of the present invention is applied to fabrication of a liquid crystal display (LCD) device as follows.

<Liquid Crystal Display>

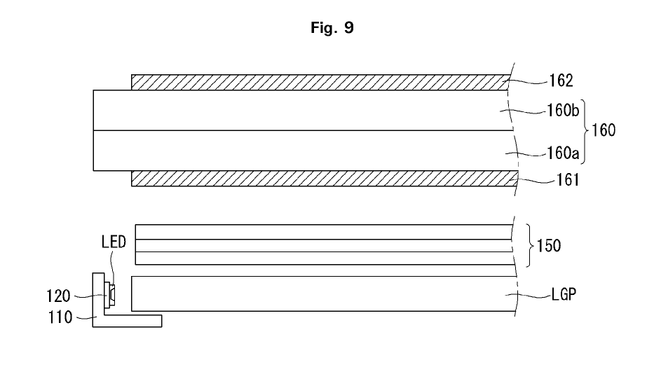

FIG. 9 is a partial sectional view of a liquid crystal display (LCD) device including a light guide plate fabricated according to an embodiment of the present invention.

As shown in FIG. 9, the LCD device includes a cover bottom 110, a substrate 120 on which an LED package is mounted, a light guide plate LGP, an optical member 150, and a liquid crystal panel 160.

The liquid crystal panel 160 serves to display an image. Subpixels including a liquid crystal layer formed between a thin film transistor (TFT) array substrate 160a and a color filter substrate 160b are included in the liquid crystal panel 160. The TFT array substrate 160a and the color filter substrate 160b include a switching transistor driven by a gate signal supplied from a gate line, a storage capacitor storing a data voltage supplied from a data line according to a switching operation of the switching transistor, a pixel electrode receiving a pixel voltage from the switching transistor, a common electrode receiving a common voltage from a common voltage line, a liquid crystal driven by an electric field formed by the pixel electrode and the common electrode, color filters converting light output according to driving of the liquid crystal into red, green, and blue colors, or the like, a black matrix preventing color mixture among the color filters, and the like. The liquid crystal panel 160 may be implemented to operate in a TN (Twisted Nematic) mode, VA (Vertical Alignment) mode, IPS (In Plane Switching) mode, FFS (Fringe Field Switching) mode, ECB (Electrically Controlled Birefringence) mode, or the like.

A lower polarizer 161 and an upper polarizer 162 are attached to the TFT array substrate 160a and the color filter substrate 160b in order to convert polarization characteristics of light made incident through the backlight unit 110, 120, LGP, 150.

The backlight unit 110, 120, LGP, 150 serves to provide light to the liquid crystal panel 160. The backlight unit 110, 120, LGP, 150 includes the cover bottom 110, the substrate 120, the light guide plate (LGP), and the optical member 150.

The cover bottom 110 serves to receive the substrate 120, the LGP, the optical member 150, or the like. The cover bottom 110 is a structure for receiving the substrate 120, the LGP, the optical member 150, and the like, and may have various shapes according to the size, or the like, of the LCD device.

The LGP serves to change a point source of light output from an LED package mounted on the substrate 120 into a surface source of light. The LPG may be fabricated by the apparatus for fabricating a light guide plate according to the first to fifth embodiments as described above, and may have such a structure as shown in FIGS. 6 to 8.

The optical member 150 serves to increase the efficiency of light output through the LGP. The optical member 150 may include sheet layers such as a diffusion sheet, a prism sheet (or lens sheet), a protection sheet, and the like. In addition, the optical member 150 may include a reflective sheet reflecting light output from the lower portion of the LGP.

As described above, according to embodiments of the present invention, the light guide plate can be continuously manufactured without having to cool it, improving productivity. Also, since the light guide plate can be cut according to the size of an LCD device to which the LGP is applicable in manufacturing the LCD device, the process efficiency can be also increased. The light guide plate fabricated according to an embodiment of the present invention can resolve the problem of the related art in which the temperature of the extruded material should be decreased, and then, the extruded material is heated again to perform roll stamping thereon, and the protective paper for protecting the extruded material is attached and then detached, and the problem in which the productivity is degraded because each sheet must be separately processed.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An apparatus for fabricating a light guide plate, the apparatus comprising:
a material supply unit supplying a material;
a first processing unit including a roll rotating to extrude the material supplied from the material supply unit; and
a second processing unit including a roll rotating to form a pattern on one surface of the extruded material before the material extruded by the first processing unit is cooled.

2. The apparatus of claim 1, wherein the first processing unit comprises;
first and second polishing rolls rotating in first and second directions to extrude the material supplied from the material supply unit, respectively; and
third and fourth polishing rolls rotating in the first and second directions to extrude the material which has been extruded by the first and second polishing rolls, respectively.

3. The apparatus of claim 1, wherein the first processing unit comprises:
first and second polishing rolls rotating in first and second directions to extrude the material supplied from the material supply unit, respectively; and
a third polishing roll rotating in the first direction to extrude the material which has been extruded by the first and second polishing rolls, respectively.

4. The apparatus of claim 2, wherein the second processing unit includes a pattern roll disposed at an upper portion or a lower portion of one of the second and third polishing rolls and rotating in the opposite direction from that of one of the second and third polishing rolls to form a pattern on one surface of the extruded material.

5. The apparatus of claim 3, wherein the second processing unit includes a pattern roll disposed at an upper portion or a lower portion of one of the second and third polishing rolls and rotating in the opposite direction from that of one of the second and third polishing rolls to form a pattern on one surface of the extruded material.

6. The apparatus of claim 2, wherein the second processing unit includes a pair of first pattern rolls disposed to be spaced apart and rotating in the first direction and a second pattern roll disposed between the pair of first pattern rolls on the pair of pattern rolls and rotating in the second direction, and the pair of first pattern rolls and the second pattern roll form a pattern on one surface of the extruded material which has passed through the fourth polishing roll.

7. The apparatus of claim 3, wherein the second processing unit includes a first pattern roll rotating in the first direction and a second pattern roll disposed on the first pattern roll and rotating in the second direction, and the first and second pattern rolls form a pattern on one surface of the extruded material which has passed through the third polishing roll.

8. The apparatus of claim 7, wherein the first and second pattern rolls form patterns each having a different shape on one surface and the other surface of the extruded material which has passed through the third polishing roll.

9. The apparatus of claim 1, wherein the second processing unit forms dot patterns on one surface of the extruded material.

10. The apparatus of claim 1, wherein the second processing unit forms dot patterns on one surface of the extruded material and patterns having a lenticular shape or a prism-like shape on the other surface of the extruded material.
